(19) United States
(12) Patent Application Publication
(10) Pub. No.: US 2020/0406691 A1
(43) Pub. Date: Dec. 31, 2020

(54) Housing for a mobile traffic monitoring device and traffic monitoring system

(71) Applicant: JENOPTIK Robot GmbH, Monheim am Rhein (DE)

(72) Inventors: Michael LEHNING, Hildesheim (DE); Einar MAAG, Solingen (DE)

(73) Assignee: JENOPTIK Robot GmbH, Monheim am Rhein (DE)

(21) Appl. No.: 16/319,577

(22) PCT Filed: Jul. 19, 2017
(86) PCT No.: PCT/EP2017/068225

§ 371 Date: Jan. 22, 2019

(30) Foreign Application Priority Data
Jul. 20, 2016 (DE) 10 2016 113 367.1

(51) Int. Cl. B60D 1/145; B60D 1/58; B60R 11/04; B60R 9/06; G08G 1/017; G08G 1/054

(52) U.S. Cl. CPC B60D 1/145; B60D 1/58; B60R 11/04; B60R 2011/004; G08G 1/0175; G08G 1/054; B60R 9/06

(57) ABSTRACT

The invention relates to a housing (102) for a mobile traffic monitoring device (104), wherein the housing (102) can be coupled to a carrier vehicle (200) via a fastening interface (108), and wherein the housing (102) is designed as a luggage transport rack.

This nonprovisional application is a National Stage of International Application No. PCT/EP2017/068225, which was filed on Jul. 19, 2017, and which claims priority to German Patent Application No. 10 2016 113 367.1, which was filed in Germany on Jul. 20, 2016, and which are both herein incorporated by reference.

### BACKGROUND OF THE INVENTION

### Field of the Invention

The present invention relates to a device of the type indicated in the independent claims.

### Description of the Background Art

In order to integrate a traffic monitoring device into a vehicle, complex conversion measures are required. It may be necessary, for example, to replace the rear window since metallized rear windows have an insufficient capacity to transmit electromagnetic waves.

### SUMMARY OF THE INVENTION

Given this situation, the approach presented here provides a housing for a mobile traffic monitoring device and a traffic monitoring system as claimed in the main claims. Advantageous developments and improvements of the housing are possible by means of the measures presented in the dependent claims.

A housing is provided for a mobile traffic monitoring device, wherein the housing can be coupled to a carrier vehicle via a fastening interface, and wherein the housing is embodied as a luggage transport case.

A traffic monitoring device can be taken to mean an electronic device for detecting and recording violations of road traffic regulations. The traffic monitoring device can comprise at least one sensor for detecting at least one vehicle, control electronics and a recording unit. A luggage transport case can be taken to mean a cuboidal container which is provided with a lid and can be opened and closed. A fastening interface can be referred to as a releasable coupling.

The fastening interface can have a receiving device for a trailer coupling of the carrier vehicle. Many vehicles have a trailer coupling, or it can easily be retrofitted. The receiving device can be designed for positive engagement and/or frictional engagement with a standardized ball head of the trailer coupling.

The fastening interface can have a receiving device for a roof rack interface of the carrier vehicle. Many vehicles have screw attachment points in the roof area and/or a roof railing. The receiving device can be designed like a roof rack.

The fastening interface can have a receiving device for an attachment of the carrier vehicle. An attachment can be an attachment plate or an equipment carrier. The attachment can also be a receptacle for a removable trailer coupling or a snow plow, for example. The attachment can be arranged on a vehicle front of the carrier vehicle. This enables the housing with the traffic monitoring device also to be mounted on the front of the carrier vehicle.

A height adjustment device can be arranged between the fastening interface and the housing. A height adjustment device can be used to raise and lower the housing. The height adjustment device makes it a simple matter to mount the housing on the carrier vehicle or remove it from the carrier vehicle.

A pivoting device can be arranged between the fastening interface and the housing. A pivoting device can be used for pivoting about one or two axes. A detection zone of the traffic monitoring device can be aligned by means of the pivoting.

The housing can have height-adjustable feet. Adjustable feet make it possible to compensate for irregularities in the ground. Adjustable feet can be raised in the coupled state in order to avoid contact with the ground.

The housing can have transport rollers. Transport rollers can be swivel casters or fixed casters. The uncoupled housing can be moved easily on transport rollers. The transport rollers can be fixable.

The housing can have a lighting unit conforming to traffic regulations. As a result, the housing can at least partially cover the lighting unit of the carrier vehicle. The lighting unit enables the housing to be transported safely with the carrier vehicle in road traffic.

A traffic monitoring system having a mobile traffic monitoring device arranged in a housing in accordance with the approach presented here is furthermore provided.

Power can be supplied to the traffic monitoring system via the fastening interface. For this purpose, the traffic monitoring system can be fitted with a power supply interface for the traffic monitoring device, said interface being designed to perform power supply to the traffic monitoring device via a receiving device or a power supply interface, associated with the receiving device, of a carrier vehicle. As a result, no battery is required in the housing.

The housing can have a dummy bicycle. The dummy bicycle can be used to disguise the traffic monitoring system.

Further scope of applicability of the present invention will become apparent from the detailed description given hereinafter. However, it should be understood that the detailed description and specific examples, while indicating preferred embodiments of the invention, are given by way of illustration only, since various changes and modifications within the spirit and scope of the invention will become apparent to those skilled in the art from this detailed description.

### BRIEF DESCRIPTION OF THE DRAWINGS

The present invention will become more fully understood from the detailed description given hereinbelow and the accompanying drawings which are given by way of illustration only, and thus, are not limitive of the present invention, and wherein:

FIG. 1 shows an illustration of a mobile traffic monitoring system in accordance with one illustrative embodiment; and

FIG. 2 shows an illustration of a mobile traffic monitoring system in accordance with one illustrative embodiment mounted on a carrier vehicle.

### DETAILED DESCRIPTION

In the following description of advantageous illustrative embodiments of the present invention, the same or similar reference signs are used for those elements with a similar action which are illustrated in the various figures, and repeated description of these elements will be dispensed with.

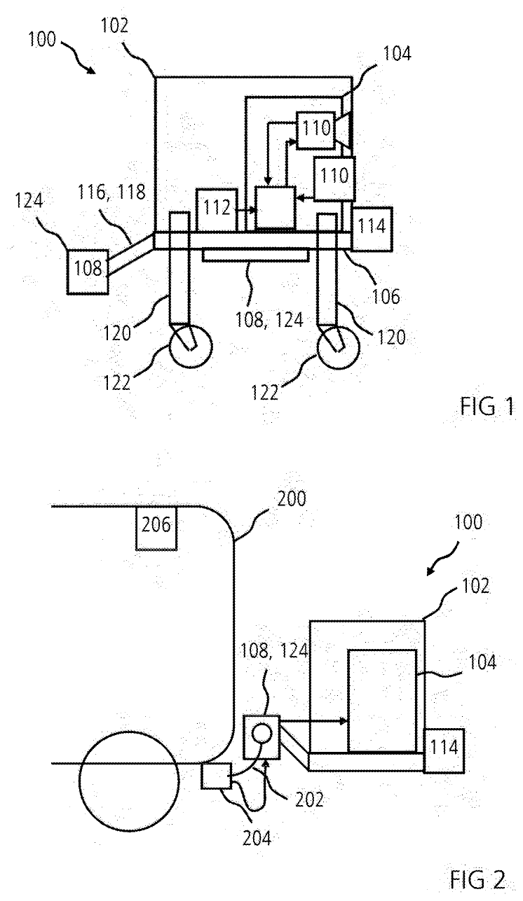

FIG. 1 shows an illustration of a mobile traffic monitoring system 100 in accordance with one illustrative embodiment. The traffic monitoring system 100 has a weatherproof housing 102 and a traffic monitoring device 104 arranged in the housing 102. The housing 102 is arranged on a carrier 106. The carrier 106 can be connected to a carrier vehicle via a fastening interface 108. The carrier 106 can be integrated into the housing 102. The housing 102 is box-shaped and surrounds the traffic monitoring device 104. The housing 102 is embodied in the manner of a luggage transport case. For this purpose, the luggage transport case 102 can have a lid on the upper side, enabling it to be opened and closed quickly and easily. As an alternative, the housing 102 designed as a luggage transport case can have a bottom element and a lid element. The bottom element can be connected to the lid element by releasable fastening elements. In this way, the luggage transport case can likewise be opened and closed quickly and easily. Sensors 110 of the traffic monitoring device 104 are arranged within the housing 102. At least in the region of the respective sensor 110, one wall of the housing 102 is transparent for the wavelength used for said sensor. For example, the wall is transparent in the region of a camera 110 and allows radio waves to pass through in the region of a radar sensor 110. Here, a power supply device 112 for the traffic monitoring device 104, e.g. an accumulator 112, is arranged in the housing 102. As a result, the traffic monitoring system 100 is autonomous and can be used apart from the carrier vehicle at a measuring location.

The housing 102 has a lighting unit 114 conforming to licensing regulations. For example, the lighting unit 114 has rear lights, such as tail lights, brake lights, direction indicators, reflectors, reversing lights and rear fog lights for transportation behind the carrier vehicle. As an alternative or in addition, the lighting unit 114 has front lights for side light mode, dipped beam mode, highbeam mode and direction indication for transportation in front of the carrier vehicle. The lighting unit 114 can furthermore comprise a license plate with license plate lighting.

In one illustrative embodiment, a height adjustment device 116 is arranged between the fastening interface 108 and the carrier 106. By means of the height adjustment device 116, a position of the fastening interface 108 relative to the housing 102 can be adjusted. For example, the fastening interface 108 can be raised in order to position the fastening interface 108 for coupling to the carrier vehicle. The coupled housing 102 can likewise be raised relative to the carrier vehicle for arrangement in a transportation position. At a measuring location, the housing 102 can be positioned in a measuring position. For example, the housing 102 can be raised higher than an obstacle.

As an alternative or in addition to the height adjustment device 116, a pivoting device 118 is arranged between the fastening interface 108 and the housing 102. By means of the pivoting device 118, the traffic monitoring device 104 can be pivoted with the housing 102 at least on one axis relative to the fastening interface 108 and the carrier vehicle.

In one illustrative embodiment, the housing 102 has height-adjustable feet 120. The feet 120 can be lowered in order to set down the traffic monitoring system 100. During transportation with the carrier vehicle, the feet 120 are raised.

The housing 102 can have transport rollers 122. The traffic monitoring system 100 can be rolled to the measuring location on the transport rollers 122 in a lowered state. Here, the transport rollers 122 are arranged on the feet 120. This enables the transport rollers 122 to be raised for transportation with the carrier vehicle.

In one illustrative embodiment, the fastening interface 108 has a receiving device 124 for a trailer coupling of the carrier vehicle. Here, the weight of the traffic monitoring system 100 is supported on the trailer coupling in a manner similar to a rear carrier for bicycles.

The receiving device 124 can be replaceable. For example, a further receiving device 124 can be designed to be fastened on an attachment plate or an equipment carrier of a municipal vehicle. This enables the traffic monitoring system 100 to be arranged on a vehicle front or a vehicle rear of the carrier vehicle.

It is likewise possible for a further receiving device 124 to be designed to be screwed into a thread for a towing lug of the carrier vehicle. A further receiving device 124 can be designed to be connected to a receptacle for a snow plow or a removable trailer coupling.

In one illustrative embodiment, the housing 102 has a further fastening interface 108. Here, the further receiving device 124 is designed to be connected to a roof rack interface of the carrier vehicle. As a result, the traffic monitoring system 100 can also be arranged on the carrier vehicle.

In other words, a measuring system is mounted on a simple carrier 106 or holder 106 that can be placed on the trailer coupling.

In this case, a system already licensed for road traffic applications can be used for mounting on the trailer coupling. The measurement electronics 104 and, where appropriate, the power supply 112 can be set up on this carrier 106. The standardized plug of the trailer coupling has a power supply and connections for lighting, and therefore the measuring system can also be supplied from this power source. Very quick and economical installation of the measuring system is thereby obtained.

In one embodiment, the carrier 106 is capable of being lowered. As an option, transport rollers 122 can be integrated on the carrier 106 or the housing 102. The housing 102 can be referred to as a box 102. The transport rollers 122 can be height-adjustable like a third wheel on a caravan to ensure easy handling of the traffic monitoring system 100 or of the arrangement 100.

In various variants, the traffic monitoring device 104 can be used, for example, to detect and record speed infractions, red light infractions, toll infractions, turning infractions or spacing infractions and can be fully integrated into the arrangement/case 102. It is likewise possible for the traffic monitoring device 104 to be partially integrated, wherein the battery 112 can also be held in the motor vehicle. The power for supplying the traffic monitoring device 104 or measuring unit 104 can come from the plug socket which generally forms part of the trailer coupling. For the purpose of disguise, the traffic monitoring system 100 can have a dummy bicycle. As an option, a roof box can also be used as a housing 102. It is thereby possible to achieve the effect of surprise by the combination of known elements.

In the front solution, there is the advantage that it is possible to measure from the front and, in the case of an ambush, that the officials or operators could be on the go immediately. In this case, transportation could be provided by way of the rear trailer coupling. After parking in the measuring position, the carrier 106 is lowered onto the transport rollers 122 and moved by means of the rollers 122 into the front region, where the traffic monitoring system 100 is mounted on the front trailer coupling and propped up on the coupling. If there is no integrated internal power supply 112, the traffic monitoring system 100 or measuring arrangement 104 can be connected to a plug socket of the carrier vehicle. In this case, the connection can be made via an extension to the rear socket or optionally in a front socket.

FIG. 2 shows an illustration of a mobile traffic monitoring system 100 in accordance with one illustrative embodiment mounted on a carrier vehicle 200. In this case, the traffic monitoring system 100 corresponds substantially to the traffic monitoring system in FIG. 1. Here, the receiving device 124 of the fastening interface 108 is designed to receive the trailer coupling 202 of the carrier vehicle 200. The ball of the trailer coupling 202 is held by frictional engagement or positive engagement, for example. The lighting unit 114 and the traffic monitoring device 104 are supplied with electrical energy via a trailer plug socket 204 of the carrier vehicle 200. The traffic monitoring system 100 can have a low weight since no battery is required in the housing 102. When the traffic monitoring system 100 is set up, having been set down from the carrier vehicle 200, the power can be supplied via an extension cable or a separate power supply device.

Here, the carrier vehicle 200 has a roof rack interface 206. By means of a receiving device for the roof rack interface 206, the traffic monitoring system 100 can also be arranged on the roof of the carrier vehicle 200. A large detection zone can be monitored on the roof.

When the traffic monitoring system 100 is coupled, it is also possible to perform measurements while mobile or driving. In the state decoupled from the vehicle, the system 100 requires only a little space at the edge of the roadway.

In other words, FIG. 2 shows a mobile measuring system which is arranged on the standard trailer coupling 202 like a rear carrier. In this case, the measuring system has a mobile traffic monitoring device 104.

The approach presented here can replace an expensive adaptation of a window and onboard electronics for vehicle installation. This is advantageous particularly for leased vehicles 200, which cannot be structurally modified. Only a standard trailer coupling 202 with a plug socket 204 is required, and it can be easily retrofitted. The autonomous measuring system is compact and easy to handle. For example, three transport rollers for easy installation and for movement to the measurement location can be attached if the measurement is not to be performed directly from the installed position. This enables measurement to be performed in front of the vehicle 200, for example. In contrast to a trailer, there is no speed restriction in the case of installation on the trailer coupling 202.

If an illustrative embodiment comprises an “and/or” conjunction between a first feature and a second feature, this should be interpreted to mean that the illustrative embodiment has both the first feature and the second feature according to one embodiment and either only the first feature or only the second feature according to another embodiment.

The invention being thus described, it will be obvious that the same may be varied in many ways. Such variations are not to be regarded as a departure from the spirit and scope of the invention, and all such modifications as would be obvious to one skilled in the art are to be included within the scope of the following claims.

What is claimed is:

1. A housing for a mobile traffic monitoring device, wherein the housing can be coupled to a carrier vehicle via a fastening interface, and wherein the housing is embodied as a luggage transport case.

2. The housing as claimed in claim 1, in which the fastening interface has a receiving device for a trailer coupling of the carrier vehicle.

3. The housing as claimed in claim 1, in which the fastening interface has a receiving device for a roof rack interface of the carrier vehicle.

4. The housing as claimed in claim 1, in which the fastening interface has a receiving device for an attachment of the carrier vehicle.

5. The housing as claimed in claim 1, in which a height adjustment device is arranged between the fastening interface and the housing.

6. The housing as claimed in claim 1, in which a pivoting device is arranged between the fastening interface and the housing.

7. The housing as claimed in claim 1, having height-adjustable feet.

8. The housing as claimed in claim 1, having transport rollers.

9. The housing as claimed in claim 1, having a lighting unit conforming to traffic regulations.

10. The housing as claimed in claim 1, having a dummy bicycle.

11. A traffic monitoring system having a mobile traffic monitoring device arranged in a housing as claimed in claim 1.

12. The traffic monitoring system as claimed in claim 11, having a power supply interface for the traffic monitoring device, said interface being designed to perform power supply to the traffic monitoring device via a receiving device or a power supply interface, associated with the receiving device, of a carrier vehicle.
